(19) United States
(12) Patent Application Publication
(10) Pub. No.: US 2005/0201695 A1
(43) Pub. Date: Sep. 15, 2005

(54) Hermetically-sealed lasers and methods of manufacturing

(76) Inventor: Mina Farr, Palo Alto, CA (US)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 11/040,483

(22) Filed: Jan. 21, 2005

Related U.S. Application Data
(60) Provisional application No. 60/538,201, filed on Jan. 22, 2004.
(60) Provisional application No. 60/577,035, filed on Jun. 4, 2004.

(51) Int. Cl. G02B 6/36

(52) U.S. Cl. 385/94

(57) ABSTRACT

A hermetically-sealed laser can be constructed without the need for packaging in larger form factors, such as transistor outline cans. In one implementation, a substrate, such as a silicon substrate, has a tub formed therein. The tub can be formed using a wet-etch, photolithographic, or any otherwise suitable etching process. An optical source or detecting component, such as a laser, is then placed in the tub. If appropriate, other suitable optical signal generating, receiving, or detecting components, can also be placed in the tub with the optical source or detecting component. The optical source component is positioned the tub in a manner that focuses an optical signal emanating therefrom with an aspheric glass lens. The glass lens and substrate material are then joined together to form the hermetic seal. Processes and systems are disclosed for creating multiple hermetically-sealed optical components using mass-production techniques.

### CROSS-REFERENCE TO RELATED APPLICATIONS

This application claims the benefit of priority to U.S. Provisional Patent Application No. 60/538,201, filed on Jan. 22, 2004, entitled “Hermetically-sealed Lasers and Methods of Manufacturing”, and to U.S. Provisional Patent Application No. 60/577,035, filed on Jun. 4, 2004, entitled “Integrated Optical Devices”. The entirety of the foregoing patent applications are each incorporated by reference herein.

### BACKGROUND OF THE INVENTION

1. The Field of the Invention

The invention generally relates to optical components. More specifically, the invention relates to hermetically-sealed lasers and methods for manufacturing the same.

2. The Relevant Technology

In the field of data transmission, one method of efficiently transporting data is through the use of fiber-optics. Digital data is propagated through an optical fiber using light emitting diodes or lasers. Light signals allow for extremely high transmission rates and very high bandwidth capabilities. Also, light signals are resistant to electromagnetic interferences that would otherwise interfere with electrical signals. Light signals are more secure because they do not allow portions of the signal to escape from the optical fiber as can occur with electrical signals in wire-based systems. Light also can be conducted over greater distances without the signal loss typically associated with electrical signals on copper wire.

In a typical fiber-optic data transmission scenario, a digital device such as a computer, digital video player/receiver, digital monitor, etc. is configured to function on a fiber-optic network. Such digital devices typically communicate internally using electronic signals. To convert electronic signals to optical signals for transmission on a optical fiber, a digital device often uses a transmitting optical subassembly (TOSA). A TOSA uses the electronic data to drive a laser diode or light emitting diode to generate the optical signal.

One example of a TOSA construction includes a semiconductor laser that has been placed on a silicon substrate. The semiconductor laser is interfaced with an electrical interface such that an electronic signal can drive the semiconductor laser. The semiconductor laser must then be packaged for use in a TOSA. Typically this is done by placing the laser in a transistor outline (TO) can. The TO can with the laser inside is then hermetically-sealed. The TO can has an aperture that allows the laser light to pass through. Sometimes this aperture also includes a lens for focusing the laser light. Alternatively, external lenses may be used to focus the laser light into optical fibers. The TO can, including the laser, is then integrated into a TOSA. The use of lasers packaged in TO cans is thus limited to those applications with sufficient space to accommodate a TO can package form factor.

Often the TOSA includes an optical connector that is of a standard form factor useful for interfacing with optical components. One exemplary connector form factor is Small Form-factor Pluggable (SFP). These optical connectors are generally costly.

### BRIEF SUMMARY OF THE INVENTION

These and other limitations are overcome by the present invention which relates to hermetically-sealed lasers and methods of manufacturing hermetically-sealed lasers. In one embodiment, a tub is formed in a substrate. A laser is disposed within the tub. A glass lens is connected to the substrate over the tub so as to form a hermetically-sealed laser. This construction allows for construction of a hermetically-sealed laser with a form factor considerably smaller than, for example, a TO (transistor outline) can form factor. Additionally, the integrated lens reduces the need for external lenses. A fiber-interface part may also be added to the construction to reduce or eliminate the need for additional optical connectors.

In one implementation, manufacturing a hermetically-sealed laser includes wet-etching a wafer to form a tub therein, and disposing a laser within the tub. A portion of the wafer around the tub is coated with metal, and a glass lens is similarly coated to substantially match up with the metal on the wafer. The lens and the laser are then actively aligned. The tub is hermetically-sealed by soldering the glass lens to the wafer at the metal coatings on the wafer and the glass lens.

Another embodiment of the invention includes a method for manufacturing a plurality of hermetically-sealed lasers. The method includes wet-etching a wafer to form a number of tubs in the wafer, and disposing a laser in each of the tubs at a predetermined space interval. The space interval is within a predetermined tolerance. The wafer and the glass lenses are selectively coated with metal such that after the glass lenses are aligned with the lasers, the lasers are hermetically-sealed by soldering the glass lens to the wafer at the metal coatings. The wafer and glass assembly is cut to form a number of discrete, hermetically-sealed lasers.

These and other advantages and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 illustrates a perspective view of a laser assembly including some aspects of embodiments of the present invention;

FIG. 2 illustrates a cut-away view of a laser assembly that includes some aspects of embodiments of the present invention;

FIG. 3 illustrates a perspective view of an array of laser components; and

FIG. 4 illustrates a perspective view of discrete lasers formed from an array of laser components.

### DETAILED DESCRIPTION OF THE INVENTION

The present invention relates to systems, methods, and apparatus for creating hermetically-sealed optical assemblies for use in an optical transmission and reception system. As will be understood in greater detail from the following description, a hermetically-sealed laser can be constructed without the need for packaging in bulky form factors, such as TO cans, to obtain an appropriate hermetic seal. The following description further provides for processes and systems for creating multiple hermetically-sealed optical components using mass-production techniques.

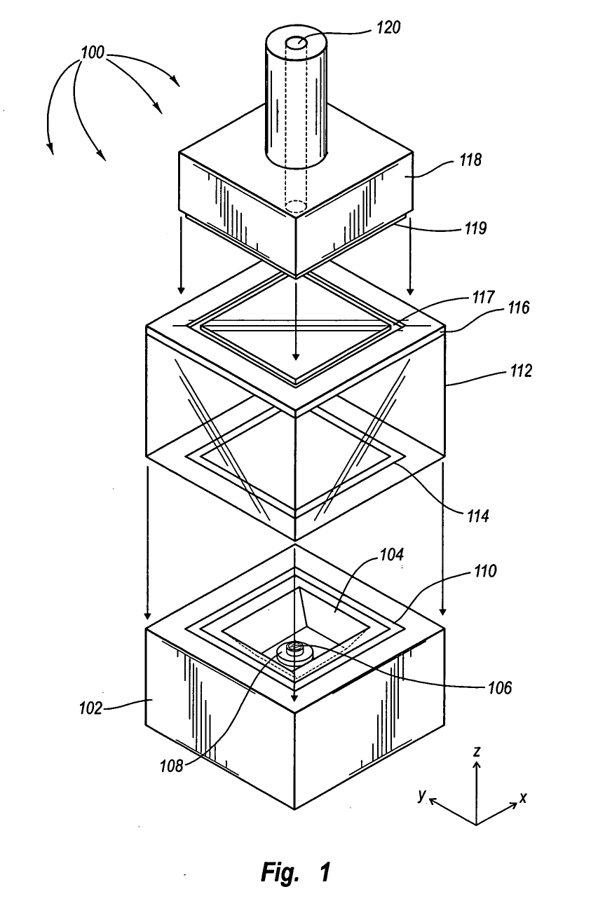

For example, FIG. 1 illustrates an exploded view of a transmitter optical subassembly (TOSA) 100 in accordance with an implementation of the present invention. A silicon substrate 102 has a tub 104 formed within it. The tub 104 is formed in one embodiment of the invention through a photolithographic wet-etch process. Other methods may also be used to form the tub 104. A laser 106 is disposed within the tub 104. The laser 106 can be placed into the tub as a discrete component. Alternate embodiments of the invention include the laser being formed by a semiconductor manufacturing process directly onto the silicon substrate 102. Other viable methods may also be used to dispose the laser 106 into the tub 104.

In some embodiments of the invention a monitor photodiode 108 can also be formed within the tub 104. The monitor photodiode 108 can be used to actively control the output of the laser 106. Namely, the monitor photodiode 108 monitors the emissions of the laser 106 and provides a source of feedback to a control circuit that controls the laser 106. The monitor photodiode 108 can be formed directly onto the silicon substrate 102 through a semiconductor manufacturing process such as photolithography. In other embodiments of the invention the monitor photodiode 108 can be a discrete component placed in the tub 104. The monitor photodiode 108 can be used, for example, to measure and/or control the power of the laser 106 as well as the wavelength output by the laser 106. Any suitable method for disposing the monitor photodiode 108 in the tub 104 can be used.

The substrate 102 is selectively coated as illustrated by a metallic coating 110. The metallic coating 110 surrounds the tub in this example and can be useful as a sealant or for forming a hermetic seal. For example, a lens can also be selectively coated with a metallic coating, such that the metallic coating of the lens can be soldered to the metallic coating on the substrate. Thus, the laser is hermetically-sealed between the substrate and the lens. The metallic coating 110 in the example shown in FIG. 1 is formed to surround the tub 104. The metallic coating 110 can be formed through a lithographic process as a part of the process for forming the tub 104.

The TOSA 100 further includes a lens 112. The lens 112 can be an etched, aspheric glass lens. The lens 112 can also include a metallic coating 114 used to solder the lens 112 to the silicon substrate 102. As such, the metallic coating 114 can be formed on the lens 112 with planar geometries similar to the metallic coating 110 on the silicon substrate 102. In one embodiment of the invention, coating the lens 112 and silicon substrate 102 with metallic coatings 114 and 110 can be performed during photolithographic processes that include steps for etching the aspheric lens 112 and the silicon substrate 102.

In some embodiments of the invention, the lens includes an optical coating 116. In one embodiment of the invention, the optical coating 116 is an antireflective coating to reduce reflections of a light signal back into the laser 106. The optical coating 116 can also be a variable attenuation coating. The optical coating can be applied to either side of the lens. When fabricating the TOSA 100, the lens 112 can be actively aligned with the laser 106 to focus a beam from the laser into an appropriate path. Active alignment may involve activating the laser 106 and adjusting the alignment of the lens 112 and laser 106 until a beam from the laser is properly focused by the lens. Thus, the planar geometries of the metallic coatings 114 and 110 should be such that a hermetic seal can be made for different alignments of the laser 106 and the lens 112. The lens 112 and silicon substrate 102 are then attached, in this example, by soldering the metallic coating 110 on the silicon substrate 102 to the metallic coating 114 on the lens 112. This hermetically-seals the tub with the laser 106 inside.

Some embodiments of the invention also include a fiber interface part 118 useful for interfacing a fiber stub with a beam from the laser such that the beam from the laser can be propagated onto the fiber stub. The fiber interface part 118 can be molded plastic or any other suitable material. The fiber interface part 118 can be connected to the lens 112 using optical epoxy. The fiber interface part 118 includes a receptacle 120 for receiving a fiber stub.

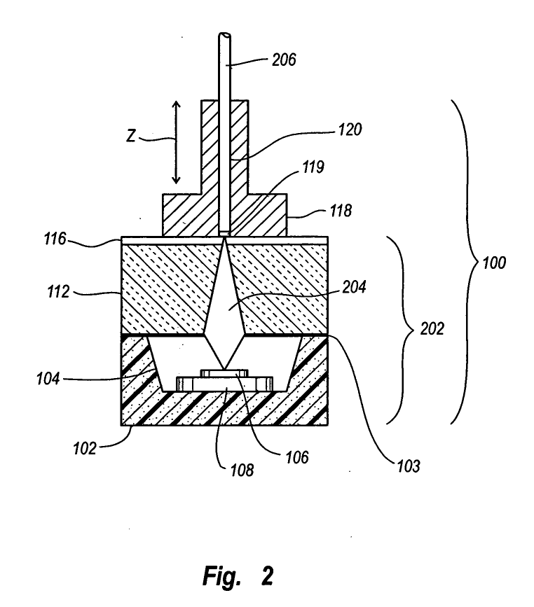

In accordance with still further embodiments of the invention, the fiber interface part 118 includes a fiber stop 119 (FIG. 2) formed on the molded part 118 and positioned such that the input end of a fiber stub will rest at substantially the focal point of the glass lens 112. This fiber stop can be useful in embodiments where the thickness and position of the laser 106 is closely controlled. In other embodiments of the invention, a fiber stub placed in the receptacle 120 is selectively movable to allow the input end of the fiber stub to be placed at the focal point of the glass lens 112. This can be useful in cases where the laser 106 varies in thickness from part to part. The fiber stub can then be epoxied into place in the receptacle 120. In one embodiment of the invention, the fiber receptacle 120 is a Small Form-factor Pluggable (SFP) receptacle.

In one embodiment of the invention, the glass lens 112 includes an etched pit 117 formed into the lens. The fiber interface part 118 includes a protrusion 119 formed onto the fiber interface part 118 corresponding to the etched pit 117. This allows the fiber interface part 118 to be appropriately aligned with the glass lens 112 when attaching the fiber interface part 118, which can be a plastic molded part, to the lens. The fiber interface part is attached such that light from the laser 106 can be directed into the input of a fiber stub in the receptacle 120.

FIG. 2 illustrates a cutaway view of the transmitter optical subassembly 100. Included within the transmitter optical subassembly 100 is a hermetically-sealed laser assembly 202. The hermetically-sealed laser assembly 202 emits a beam 204 emanating from the laser 106. The beam 204 travels towards the lens 112 where it is launched into a fiber 206 that is disposed in the receptacle 120 of the fiber interface part 118. The fiber 206 can be selectively placed in the receptacle 120 such that by moving the fiber along what is labeled the Z axis, the beam 204 is launched appropriately into the fiber 206. In this way, the fiber 206 can be placed in an optimal position for launching the beam 204. The fiber 206 can be secured in place using epoxy or any other suitable fastening means.

FIG. 2 also shows that a sealant means can be implemented at an interface 103, the sealant means being instrumental for hermetically-sealing the laser 106 within the laser assembly 202. In one example, the hermetic seal at the interface 103 is formed by soldering a metallic coating 114 (see FIG. 1) of the lens 112 to a metallic coating 110 (see FIG. 1) of the silicon substrate 102.

The laser 106 disclosed herein can be a vertical cavity surface emitting laser (VCSEL) that emits the beam 204 along the Z axis. Other embodiments of the invention may include other types of lasers, such as, but not limited to an edge emitter laser that emits the beam 204 from the edge of the laser substantially perpendicular, or at any other angle to the Z axis. In FIGS. 1 and 2, the laser 106 is arranged such that the laser beam 204 can be directed into the Z axis by reflecting the beam 204 off of one of the walls of the tub 104. Alternatively, when the beam 204 is in a plane different than the Z axis, whether perpendicular or at some other angle, the beam 204 can be rotated into the Z axis by using a micro prism or other reflective elements. In one embodiment of the invention a 45° micro prism is used.

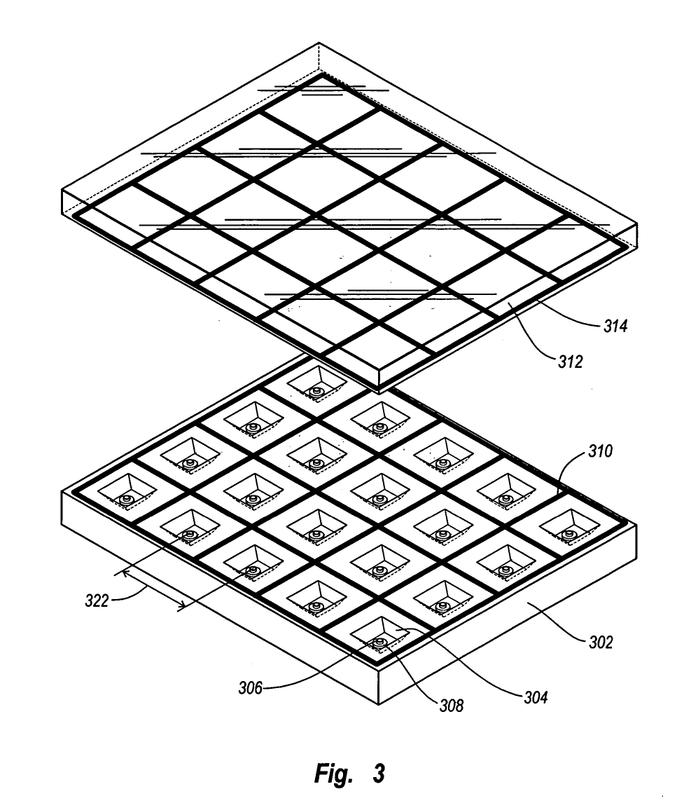

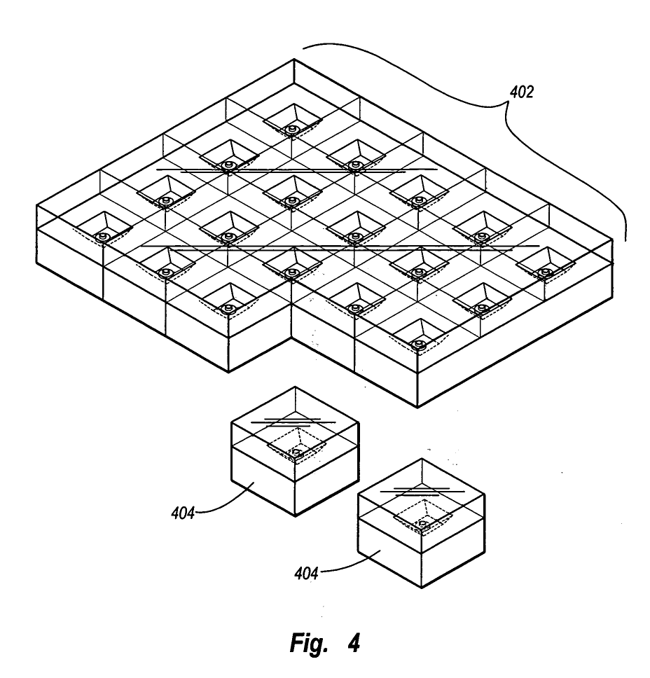

FIGS. 3 and 4, and the accompanying text, illustrate an exemplary method for making hermetically-sealed lasers. In particular, FIG. 3 shows a silicon substrate 302, on which is formed a plurality of tubs 304. The tubs 304 can be formed through a wet-etch process, such as by using photolithography, or by any other appropriate method for constructing such tubs 304. Disposed within the tubs 304 are lasers 306. Laser 306 can be discrete components placed in the tub 304, or can be formed by a semiconductor manufacturing process or by any other suitable method. The lasers 306 are placed at some predetermined distance 322 from each other. The lasers 306 can be placed using a “pick-and-place” machine, or any other suitable apparatus or process for placing the lasers 306 within the tub 304. The distance 322 between the lasers 306 is closely controlled within some predetermined tolerance, such as, for example, a tolerance of 1 micron.

Monitor photodiodes 308 can also be disposed in the tubs 304. The monitor diodes can also be discrete components or components made directly on the silicon substrate 302. The monitor photodiodes 308 can generate feedback signals used to control the wavelength and/or power emitted by the lasers 306. This can be useful as the lasers 306 age, causing changes in output, or when conditions in which the lasers 306 are operating change resulting in a need for a change in the laser beam emitted, or for other reasons.

A lens array 312 is actively aligned with the lasers 306 and attached to the silicon substrate 302 and bonded such that an array of hermetically-sealed lasers is created. The lens array 312 can be, for example, an etched, aspheric glass lens array. The lens array 312 can be formed during a wet etch process such that the focal points of individual lenses in the lens array 312 align with the lasers 306. As such, all lasers can be appropriately aligned with the lens array 312 at one time. As mentioned above, the lasers 306 can be placed in the tubs 304 using a pick and place method with a 1 micron tolerance. This tolerance is sufficiently tight to allow fabrication of the entire lens array for attachment to the substrate 302 while ensuring that all lasers 306 are focused by a lens in the lens array 312.

The hermetical seal can be formed in one embodiment of the invention by soldering the silicon substrate 302 to the lens array 312. The lens array 312 includes a metal coating 314 that may have been formed using photolithographic techniques, or by any other suitable method. The substrate 302 includes a corresponding metal coating 310 with a geometry similar to the metal coating 314 on the lens array 312. The metal coatings 314 and 310 are such that the position of the substrate 302 and lens array 312 can be arranged with respect to each other to align the lasers 306 with the lens array 312 and still provide sufficient overlap of the metal coatings 314 and 310 to hermetically-seal the lasers 306 when the coatings 314 and 310 are soldered together.

The array of hermetically-sealed lasers shown in FIG. 4 and designated generally as 402 may then be cut into individual hermetically-sealed lasers such as those illustrated and designated 404. Thus hermetically-sealed lasers can be fabricated without the need for encapsulating the laser in a TO can or other bulky packaging.

The hermetically-sealed laser can be mounted on a printed circuit board using conventional methods and techniques, such that an appropriate interface to the hermetically-sealed laser 404 exists. One interface that can be used is the fiber interface part 118 shown in FIG. 1.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A hermetically-sealed laser assembly for use in fiber-optic devices, the laser comprising:
a substrate having a tub formed therein;
a laser disposed in the tub; and
an aspheric glass lens coupled to the substrate over the tub, such that the aspheric glass lens and the substrate form a hermetic seal.

2. The hermetically-sealed laser assembly of claim 1, wherein the substrate comprises silicon.

3. The hermetically-sealed laser assembly of claim 1, further comprising a monitor photo diode disposed in the tub.

4. The hermetically-sealed laser assembly of claim 3, wherein the monitor photo diode is formed in the tub by a photolithographic process.

5. The hermetically-sealed laser assembly of claim 1, further comprising a sealant formed on the substrate, the sealant comprising a first metallic coating on the substrate, and a second metallic coating on the aspheric glass lens, wherein the first and second metallic coatings are coupled with a solder joint.

6. The hermetically-sealed laser assembly of claim 1, wherein the laser is a VCSEL.

7. The hermetically-sealed laser assembly of claim 1, wherein the laser is an edge emitter laser, the hermetically-sealed laser assembly further comprising a micro prism disposed in the tub, the micro prism configured to rotate light from the edge emitter laser.

8. The hermetically-sealed laser assembly of claim 1, further comprising a fiber interface part wherein the fiber interface part comprises a receptacle for receiving a fiber-optic fiber.

9. The hermetically-sealed laser assembly of claim 8, wherein the receptacle is Small Form-factor Pluggable.

10. The hermetically-sealed laser assembly of claim 8, wherein the lens comprises a pit, and the fiber interface part comprises a protrusion for aligning the fiber interface part with the lens.

11. The hermetically-sealed laser assembly of claim 8, wherein the fiber interface part further comprises a fiber stop positioned such that an input end of a fiber stub inserted into the receptacle will rest at substantially a focal point of the glass lens.

12. The hermetically-sealed laser assembly of claim 8, wherein the receptacle is configured to allow a fiber stub to be selectively movable within the receptacle for focusing a laser beam into the fiber stub.

13. The hermetically-sealed laser assembly of claim 1, further comprising a variable attenuation coating disposed on the lens.

14. A method of making a hermetically-sealed laser assembly, the method comprising:
wet-etching a wafer to form a tub therein;
disposing a laser in the tub;
aligning an aspheric glass lens with the laser; and
sealing the glass lens about the tub such that the tub and glass lens form a hermetic seal.

15. The method of claim 14, wherein sealing the glass lens about the tub further comprises selectively coating a portion of the wafer surrounding the tub with metal; selectively coating a portion of a glass lens with metal; and soldering the glass lens to the wafer at the metal coatings of the wafer and the glass lens.

16. The method of claim 14, wherein disposing a laser in the tub further comprises placing an edge emitter laser in the tub, such that a surface of the tub reflects a beam from the edge emitter laser into a micro prism.

17. The method of claim 14, further comprising applying a variable attenuation coating on the glass lens.

18. The method of claim 14, further comprising attaching a plastic molded part to the lens.

19. The method of claim 18, further comprising forming pits in the glass lens, and forming protrusions on the plastic molded part, wherein the pits and the protrusions are reciprocally configured for alignment.

20. The method of claim 18, further comprising forming a fiber stop on the molded part for stopping a fiber stub, such that an input end of the fiber stub is stopped at a focal point of the glass lens.
